(19) United States
(12) Patent Application Publication
(10) Pub. No.: US 2025/0132713 A1
(43) Pub. Date: Apr. 24, 2025

(54) TRANSMISSION COMPONENT ASSEMBLY

(71) Applicant: SonicMEMS (ZhengZhou) Technology Co.,Ltd., Zhengzhou (CN)

(72) Inventors: Yi-Hsiang Chiu, Zhengzhou (CN); Rei Jinchi, Zhengzhou (CN); Hsien-Tsong Chen, Zhengzhou (CN)

(21) Appl. No.: 18/418,838

(22) Filed: Jan. 22, 2024

(30) Foreign Application Priority Data
Oct. 24, 2023 (TW) 112140680

(51) Int. Cl. H02P 23/16; G01S 15/08; G01S 15/88

(52) U.S. Cl. CPC H02P 23/16; G01S 15/08; G01S 15/88

(57) ABSTRACT

A transmission component assembly includes a transmission module, a short-range ultrasonic sensor, and a microprocessor. The transmission module includes a motor, a rotating shaft, and a gear wheel. The gear wheel includes a plurality of teeth with different lengths. Each of the teeth corresponds to a rotation angle of the rotating shaft. The motor drives the rotating shaft and the gear wheel to rotate. A sensing distance between the short-range ultrasonic sensor and the gear wheel is less than 8 centimeters. The short-range ultrasonic sensor generates an ultrasonic signal with a frequency greater than 500 KHz, and receives an ultrasonic reflection signal reflected by the gear wheel. A transmitting angle and a receiving angle of the short-range ultrasonic sensor are less than 10 degrees. The microprocessor calculates the rotation angle based on the sensing signal converted from the ultrasonic reflection signal, and transmits a driving signal to the motor.

### CROSS-REFERENCE TO RELATED APPLICATION

This non-provisional application claims priority under 35 U.S.C. § 119 (a) to patent application No. 112140680 filed in Taiwan, R.O.C. on Oct. 24, 2023, the entire contents of which are hereby incorporated by reference.

### BACKGROUND

### Technical Field

The present invention relates to transmission components, and in particular, to a transmission component assembly including an ultrasonic sensor.

### Related Art

With the development of new technologies such as the Internet of Things, Industry 4.0, and electric vehicles in recent years, various sensors combined with traditional machinery are gradually changing the industrial ecology. A current sensor includes an ultrasonic sensor, an optical sensor, a lens, or the like. In general, the optical sensor is the cheapest. In operation, sensing is determined by blocking/reflecting or transmitting light. A traditional robotic arm is usually applicable to sensing of start/stop. However, the sensing manner is susceptible to interference from debris or noise, which leads to an overall malfunction of a device.

The lens is an important sensor for various detections nowadays and for the electric vehicle to sense the surrounding environment. However, the lens captures an image. For image analysis, the required arithmetic unit and software are relatively expensive, and even the training of artificial intelligence is needed to achieve accurate determination. In addition, insufficient light in an environment may lead to inaccurate determination.

### SUMMARY

In order to resolve the problems in the prior art, a transmission component assembly is provided herein. The transmission component assembly includes a transmission module, a short-range ultrasonic sensor, and a microprocessor. The transmission module includes a motor, a rotating shaft, and a gear wheel. The motor is connected to the rotating shaft. The gear wheel includes a through hole and a plurality of teeth. The rotating shaft passes through the through hole. Lengths of the teeth are not equal, and each of the teeth corresponds to a rotation angle of the rotating shaft. The motor drives the rotating shaft and the gear wheel to rotate. The short-range ultrasonic sensor is arranged on a side of the gear wheel and is configured to generate an ultrasonic signal. A frequency of the ultrasonic signal is greater than 500 KHz. A transmitting angle of the short-range ultrasonic sensor is less than 10 degrees. A sensing distance between the short-range ultrasonic sensor and the gear wheel is less than 8 centimeters. The short-range ultrasonic sensor is further configured to receive an ultrasonic reflection signal reflected by the gear wheel. A receiving angle is less than 10 degrees. The ultrasonic reflection signal is converted into a sensing signal and transmitted. The microprocessor is electrically connected to the motor and the short-range ultrasonic sensor, and is configured to receive the sensing signal, calculate the corresponding rotation angle based on the sensing signal, and transmit a driving signal to the motor based on the rotation angle.

In some embodiments, the frequency of the ultrasonic signal is in a range of 600 KHz to 1200 MHZ, the transmitting angle and the receiving angle thereof are in a range of 2 degrees to 7 degrees, and the sensing distance is in a range of 0.2 centimeters to 4 centimeters.

In more detail, in some embodiments, the frequency of the ultrasonic signal is in a range of 650 KHz to 800 MHZ, the transmitting angle and the receiving angle thereof are in a range of 3 degrees to 5 degrees, and the sensing distance is in a range of 0.3 centimeters to 3 centimeters.

In some embodiments, the short-range ultrasonic sensor includes an ultrasonic transmitting module and an ultrasonic receiving module. The ultrasonic transmitting module and ultrasonic receiving module each include at least a piezoelectric micromachined ultrasonic transducer (PMUT).

In more detail, in some embodiments, the ultrasonic transmitting module and the ultrasonic receiving module each include a plurality of PMUTs, and the PMUTs are arranged in an array.

In some embodiments, the motor is a brushless direct current motor. In more detail, in some embodiments, the motor is a stepping motor.

In some embodiments, the motor is a servo motor.

In some embodiments, the gear wheel is an eccentric gear wheel.

In some embodiments, the rotating shaft is a ball screw.

As described in the foregoing embodiments, the transmission component assembly is designed through the short-range ultrasonic sensor and the gear wheel having teeth of different lengths, and can determine angles of rotation at rotation positions of various machines, making operations more accurate, and can be applied to an environment lacking light, and an overall cost of a device is reduced.

### BRIEF DESCRIPTION OF THE DRAWINGS

FIG. 1 is a side view of an embodiment of a transmission component assembly.

FIG. 2 is a partial top view of an embodiment of a transmission component assembly.

FIG. 3 is a circuit block diagram of an embodiment of a transmission component assembly.

FIG. 4 is a partial top view of another embodiment of a transmission component assembly.

### DETAILED DESCRIPTION

It should be understood that when a component is referred to as being “arranged” on another component, it may indicate that the component is directly located on the another component, or that an intermediate component may exist, and the component is connected to the another component through the intermediate component. On the contrary, when a component is referred to as being “directly arranged on another component” or “directly arranged onto another component”, it may be understood that it is explicitly defined that no intermediate component exists in this case.

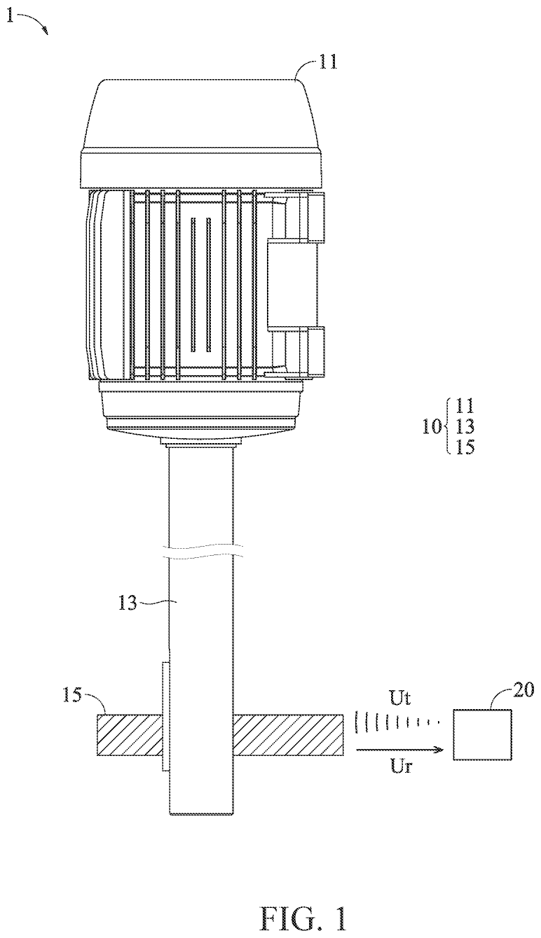

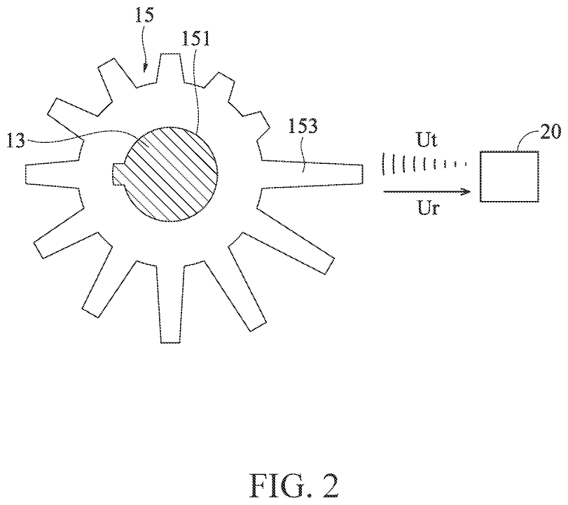

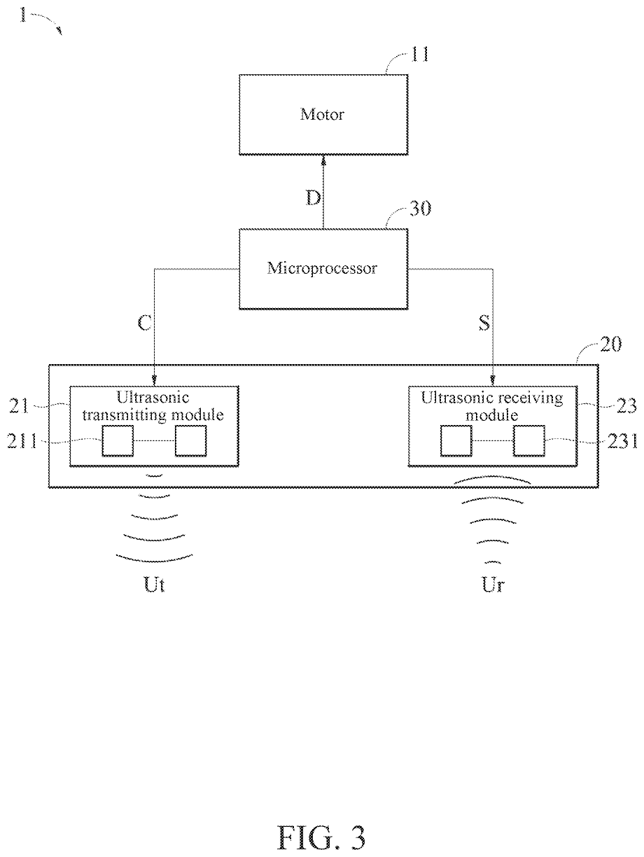

FIG. 1 is a side view of an embodiment of a transmission component assembly. FIG. 2 is a partial top view of an embodiment of a transmission component assembly. FIG. 3 is a circuit block diagram of an embodiment of a transmission component assembly. For clear display, some components are omitted in FIG. 2 and FIG. 3. As shown in FIG. 1 to FIG. 3, a transmission component assembly 1 includes a transmission module 10, a short-range ultrasonic sensor 20, and a microprocessor 30. The transmission module 10 includes a motor 11, a rotating shaft 13, and a gear wheel 15. The motor 11 is connected to the rotating shaft 13. The gear wheel 15 includes a through hole 151 and a plurality of teeth 153. The rotating shaft 13 passes through the through hole 151. Lengths of the teeth 153 are not equal, and each of the teeth 153 corresponds to a rotation angle of the rotating shaft 13. The motor 11 drives the rotating shaft 13 and the gear wheel 15 to rotate.

The short-range ultrasonic sensor 20 is arranged on a side of the gear wheel 15 and is configured to generate an ultrasonic signal Ut. A frequency of the ultrasonic signal Ut is greater than 500 KHz. A transmitting angle of the short-range ultrasonic sensor 20 is less than 10 degrees. A sensing distance between the short-range ultrasonic sensor 20 and the gear wheel 15 is less than 8 centimeters. The short-range ultrasonic sensor 20 is further configured to receive an ultrasonic reflection signal Ur reflected by the gear wheel 15. A receiving angle is less than 10 degrees. The ultrasonic reflection signal is converted into a sensing signal S and transmitted. The ultrasonic reflection signal Ur is converted into an electrical signal through coding herein. Preferably, in some embodiments, the frequency of the ultrasonic signal Ut is in a range of 600 KHz to 1200 MHz, the transmitting angle and the receiving angle are in a range of 2 degrees to 7 degrees, and the sensing distance is in a range of 0.2 centimeters to 4 centimeters. More preferably, in some embodiments, the frequency of the ultrasonic signal Ut is in a range of 650 KHz to 800 MHZ, the transmitting angle and the receiving angle are in a range of 3 degrees to 5 degrees, and the sensing distance is in a range of 0.3 centimeters to 3 centimeters. In this case, the short-range ultrasonic sensor 20 achieves high directionality through high frequency and limited transmission/receiving, which can avoid interference from noise and a refracted wave.

The microprocessor 30 is electrically connected to the motor 11 and the short-range ultrasonic sensor 20, and first sends an instruction C to start the short-range ultrasonic sensor 20 to generate the ultrasonic signal Ut. Then, after the sensing signal S is received, the corresponding rotation angle is calculated based on the sensing signal S. In this case, the main reason is that the lengths of the teeth 153 are different, so that the short-range ultrasonic sensor 20 receives the ultrasonic reflection signal Ur at a different time. In this way, a distance may be calculated, the corresponding tooth 153 may be calculated, and the rotation angle corresponding to the rotating shaft 13 may be obtained through table look-up. The microprocessor 30 then transmits a driving signal D to the motor 11 based on the rotation angle and a desired rotation angle.

The transmission component assembly 1 may be mainly mounted to joints at which various robots such as a robotic arm, a robotic vacuum cleaner, and a service robot rotate and bend, to implement more delicate operations. The short-range ultrasonic sensor 20 has high directionality and is insusceptible to interference from ambient light, and therefore may alternatively be applied to an environment lacking light for effective determination.

Referring to FIG. 3 again, the short-range ultrasonic sensor 20 includes an ultrasonic transmitting module 21 and an ultrasonic receiving module 23. The ultrasonic transmitting module 21 is configured to transmit the ultrasonic signal Ut, and the ultrasonic receiving module 23 is configured to receive the ultrasonic reflection signal Ur. The ultrasonic transmitting module 21 and the ultrasonic receiving module 23 each may include at least a piezoelectric micromachined ultrasonic transducer (PMUT) 211/231. In this embodiment, two PMUTs 211/231 are used as an example, but one or more PMUTs may be actually used, which may be determined based on an actual operating environment.

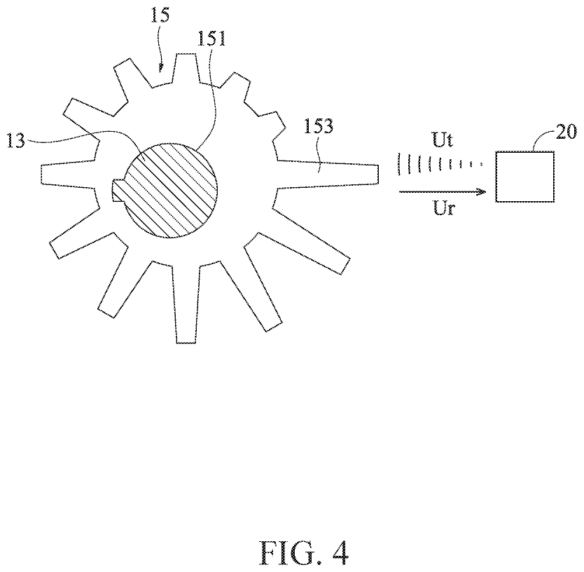

FIG. 4 is a partial top view of another embodiment of a transmission component assembly. As shown in FIG. 4, a gear wheel 15 is an eccentric gear wheel. Further, corresponding distances at positions of the gear wheel 15 are different, allowing for more detailed detection, but this is only an example and not a limitation.

When the transmission component assembly 1 is applied to different environments, different motors 11 may be used based on requirements and specifications. For example, when the transmission component assembly is applied to a battery-powered household appliance such as a robotic vacuum cleaner, a direct current brushless motor may be adopted as the motor 11. Preferably, in some embodiments, the motor 11 may be a stepping motor. When the transmission component assembly is applied to a large robotic arm powered by mains supply, the motor 11 may be a servo motor, or a stepping motor may be adopted after an alternating current is converted into a direct current. In this way, the motor 11 may be selected based on an actual product specification, space, accuracy, and function. This is merely an example, rather than a limitation.

In addition, in some embodiments, the rotating shaft 13 may be a screw. For example, a ball screw is used, which is mainly applicable to lifting or transmission in a straight-line direction. However, similarly, the above is merely an example, rather than a limitation. As long as a rotating shaft can achieve the rotating effect, the rotating shaft may be used, which depends on actual product specifications.

Based on the above, the transmission component assembly 1 is designed through the short-range ultrasonic sensor 20 and the gear wheel 15 having teeth 153 of different lengths, and may determine angles of rotation at rotation positions of various machines, making operations more accurate, and can be applied to an environment lacking light, and an overall cost of a device is reduced.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A transmission component assembly, comprising:
a transmission module, comprising a motor, a rotating shaft, and a gear wheel, wherein the motor is connected to the rotating shaft, the gear wheel comprises a through hole and a plurality of teeth, the rotating shaft passes through the through hole, lengths of the teeth are not equal, each of the teeth corresponds to a rotation angle of the rotating shaft, and the motor is configured to drive the rotating shaft and the gear wheel to rotate;
a short-range ultrasonic sensor, arranged on a side of the gear wheel and configured to generate an ultrasonic signal, wherein a frequency of the ultrasonic signal is greater than 500 KHz, a transmitting angle of the short-range ultrasonic sensor is less than 10 degrees, a sensing distance between the short-range ultrasonic sensor and the gear wheel is less than 8 centimeters, the short-range ultrasonic sensor is further configured to receive an ultrasonic reflection signal reflected by the gear wheel, a receiving angle is less than 10 degrees, and the ultrasonic reflection signal is converted into a sensing signal and transmitted; and
a microprocessor, electrically connected to the motor and the short-range ultrasonic sensor, and configured to receive the sensing signal, calculate the corresponding rotation angle based on the sensing signal, and transmit a driving signal to the motor based on the rotation angle.

2. The transmission component assembly according to claim 1, wherein the frequency of the ultrasonic signal is in a range of 600 KHz to 1200 MHZ, the transmitting angle and the receiving angle are in a range of 2 degrees to 7 degrees, and the sensing distance is in a range of 0.2 centimeters to 4 centimeters.

3. The transmission component assembly according to claim 2, wherein the frequency of the ultrasonic signal is in a range of 650 KHz to 800 MHZ, the transmitting angle and the receiving angle are in a range of 3 degrees to 5 degrees, and the sensing distance is in a range of 0.3 centimeters to 3 centimeters.

4. The transmission component assembly according to claim 1, wherein the short-range ultrasonic sensor comprises an ultrasonic transmitting module and an ultrasonic receiving module, and the ultrasonic transmitting module and the ultrasonic receiving module each comprise at least a piezoelectric micromachined ultrasonic transducer (PMUT).

5. The transmission component assembly according to claim 4, wherein the ultrasonic transmitting module and the ultrasonic receiving module each comprise a plurality of PMUTs, and the PMUTs are arranged in an array.

6. The transmission component assembly according to claim 1, wherein the motor is a brushless direct current motor.

7. The transmission component assembly according to claim 6, wherein the motor is a stepping motor.

8. The transmission component assembly according to claim 1, wherein the motor is a servo motor.

9. The transmission component assembly according to claim 1, wherein the gear wheel is an eccentric gear wheel.

10. The transmission component assembly according to claim 1, wherein the rotating shaft is a ball screw.
